(19) United States
(12) Patent Application Publication
(10) Pub. No.: US 2011/0064017 A1
(43) Pub. Date: Mar. 17, 2011

(54) RESOURCE ALLOCATION METHOD FOR MBMS IN AN INTEGRATED COMMUNICATION SYSTEM AND A RESOURCE ALLOCATION CONTROLLER THEREFOR

(75) Inventor: Tae Chul HONG, Daejeon (KR)

(73) Assignee: ELECTRONICS AND TELECOMMUNICATIONS RESEARCH INSTITUTE, Daejeon-City (KR)

(21) Appl. No.: 12/878,367

(22) Filed: Sep. 9, 2010

(30) Foreign Application Priority Data
Sep. 11, 2009 (KR) 10-2009-0085789
May 19, 2010 (KR) 10-2010-0047078

(51) Int. Cl. H04H 20/71

(52) U.S. Cl. 370/312

(57) ABSTRACT

Disclosed is a resource allocation method for an MBMS in an integrated communication system including a satellite communication system, in which a multicast service being provided by the terrestrial communication system is switched to the satellite communication system and the terrestrial communication system stops providing the same multicast service when the number of cells of the terrestrial communication system providing the same multicast service is equal to or larger than a predetermined threshold value and there is a channel available for an additional multicast service in the satellite communication system.

### CROSS-REFERENCE TO RELATED APPLICATIONS

This application claims priority under 35 U.S.C. §119 to Korean Patent Application No. 10-2009-0085789, filed on Sep. 11, 2009 and No. 10-2010-0047078, filed on May 19, 2010 in the Korean Intellectual Property Office, the disclosure of which is incorporated herein by reference in its entirety.

### TECHNICAL FIELD

The present invention relates to a resource allocation method for multimedia broadcast and multicast services (MBMS) in an integrated communication system, and more particularly, to a resource allocation method for MBMS in an integrated communication system including a satellite communication system and a resource allocation controller therefor.

### BACKGROUND

The existing mobile communication system can provide only communication services and uses a separate broadcast system (including a satellite or a mobile broadcast equipment) in order to provide broadcast services. However, the latest trend is to provide convergence services of broadcast and communication. In order to keep pace with the trend, broadcast and multicast services in a mobile communication system have been considered. As representative schemes, there are Multimedia Broadcast Multicast Service (MBMS) of 3rd Generation Partnership Project (3GPP), Broadcast Multicast Service (BCMCS) of 3GPP2, and Multicast Broadcast Service (MBS) of MobileWiMax (Wibro of Korea). A portion of bandwidth allocated for the communication services is allocated to the multicast broadcast and multicast services to provide broadcast services using the communication system.

In addition, it is considered to interwork the next-generation communication systems, which are being discussed latest, with other systems. Therefore, the next-generation communication system is being evolved to provide services at any time and anywhere by integrating a wireless LAN, the mobile communication, the satellite communication, etc.

It is expected that the next-generation communication system can maximize the advantages of each communication scheme by sharing resources of various communication systems as well as securing the continuity of services simply using a handover. In other words, since it is advantageous to use the satellite communication system due to its global characteristic for the broadcast and multicast services provided by the terrestrial mobile communication system, the broadcast and multicast services can be more efficiently provided by interworking the terrestrial mobile communication system with the satellite communication system to provide services.

### SUMMARY

The present invention proposes to solve the above-mentioned technical problems. It is an object of the present invention to provide a resource allocation method to efficiently use resources to provide broadcast and multicast services in an integrated communication system including a satellite communication system.

It is another object of the present invention to provide a resource allocation controller used in an integrated communication system using a resource allocation method so as to effectively use resources used to provide broadcast and multicast services.

According to an aspect of the present invention, there is provided a resource allocation method in an integrated communication system including a first communication system and a second communication system capable of providing multicast services to the same area as of the first communication system, wherein each of the first communication system and the second communication system has a broadcast channel for providing broadcast services, a multicast channel for providing multicast services, a communication channel for providing communication services, and a convertible channel which can be used for either communication services or multicast services; and the first communication system and the second communication systems selectively providing communication services or multicast services through the convertible channel.

Here, the first communication system is a terrestrial communication system, the second communication system is a satellite communication system, and the multicast service being provided by the terrestrial communication system is switched to the satellite communication system and the terrestrial communication system stops providing the multicast service when the number of cells providing the same multicast service among the cells of the terrestrial communication system is equal to or larger than a predetermined threshold value and there is a channel available for an additional multicast service in the multicast channel or the convertible channel of the satellite communication system.

Also, the first communication system may be a terrestrial communication system, and the multicast service being provided by the terrestrial communication system is switched to the second communication system and the terrestrial communication system stops providing the multicast service when the capacity of the communication channel of the terrestrial communication system is insufficient and there is a channel available for an additional multicast service in the multicast channel or the convertible channel of the second communication system. Preferably, the second communication system is a satellite communication system, and, when two or more multicast services are being provided by the terrestrial communication system, a multicast service provided by most cells among the cells of the terrestrial communication system is switched to the satellite communication system.

When the capacity of the communication channel of the second communication system is insufficient and there is a channel available for an additional multicast service in the multicast or the convertible channel of the first communication system, the multicast service being provided by the second communication system may be switched to the first communication system and the second communication system may stop providing the multicast service. Preferably, the first communication system is a terrestrial communication system, the second communication system is a satellite communication system, and, when two or more multicast services are being provided by the satellite communication system, a multicast service which can be provided by least cells among the terrestrial communication system is switched to the terrestrial communication system.

When the first communication system is a terrestrial communication system, the second communication system may also be a terrestrial communication system of a different kind from the first terrestrial communication system. In particular, the second communication system may be an ancillary terrestrial component (ATC) that uses the same frequency as a satellite communication system to provide services in a shadow area on a ground.

According to another aspect of the present invention, there is provided a resource allocation method in an integrated communication system including a terrestrial communication system, a satellite communication system, and a controller connected to both the terrestrial communication and the satellite communication system, comprising: the controller determining whether the number of cells providing the same multicast service among the cells of the terrestrial communication system is equal to or larger than a predetermined threshold value and there is a channel available for an additional multicast service in the satellite communication system; if it is determined that the number of cells providing the same multicast services among the cells of the terrestrial communication system is equal to or larger than a predetermined threshold value and there is a channel available for an additional multicast service in the satellite communication system, the controller performing a control to switch the multicast service being provided by the terrestrial communication system to the satellite communication system and to stop the multicast service being provided by the terrestrial communication system.

According to another aspect of the present invention, there is provided a resource allocation controller for controlling resource allocation for multicast services in an integrated communication system including a terrestrial communication system and a satellite communication system, characterized in that: the controller is connected to the terrestrial communication system and the satellite communication system to receive information on services currently provided by the terrestrial communication system and the satellite communication system, and, when the number of cells providing the same multicast service among cells of the terrestrial communication system is equal to or larger than a threshold value and there is a channel available for an additional multicast service in the satellite communication system, the controller performs a control to switch the multicast service being provided by the terrestrial communication system to the satellite communication system and to stop the multicast service being provided by the terrestrial communication system.

If a resource allocation method of the present invention is applied in the integrated communication system, the resources for providing the broadcast and multicast services are efficiently used, thereby making it possible to provide more services to the users from the same resources.

Other features and aspects will be apparent from the following detailed description, the drawings, and the claims.

### BRIEF DESCRIPTION OF THE DRAWINGS

FIG. 1 is a diagram showing cells of a satellite communication system and a terrestrial communication system;

FIG. 2 is an arrangement example of a broadcast and multicast channel, a communication channel, and a convertible channel according to an exemplary embodiment of the present invention;

FIG. 3 is a block diagram showing a concept of a controller disposed between a terrestrial communication system and a satellite communication system in an integrated communication system according to an exemplary embodiment of the present invention;

FIG. 4 is a flowchart showing an operation in a cell of a terrestrial communication system when applying a resource allocation method according to an exemplary embodiment of the present invention;

FIG. 5 is a flowchart showing an operation in a cell of a satellite communication system when applying a resource allocation method according to an exemplary embodiment of the present invention; and

FIG. 6 is a flowchart showing an operation of a controller when applying a resource allocation method according to an exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

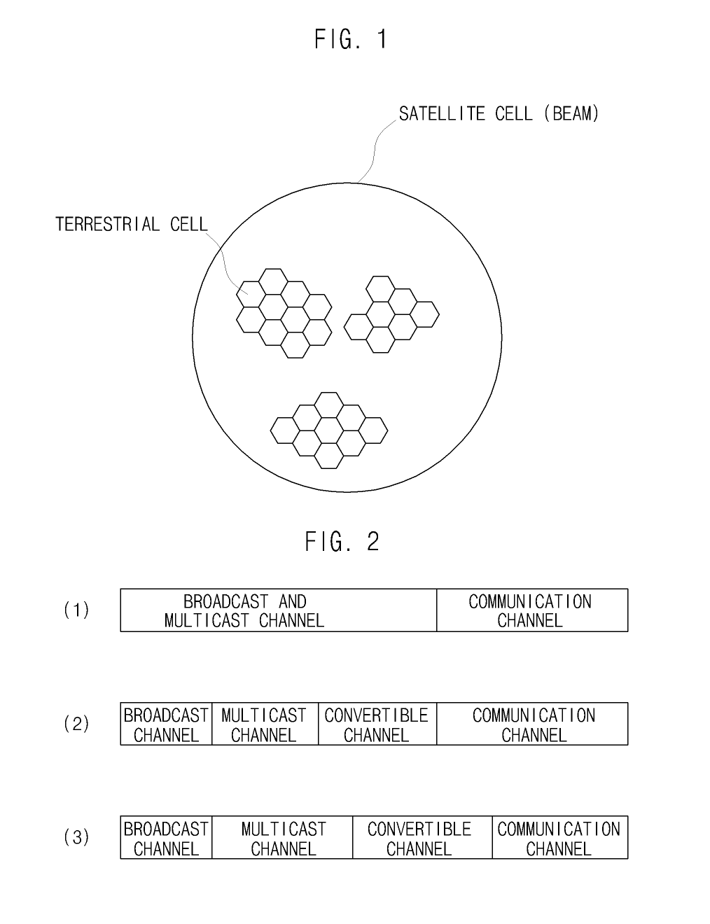

FIG. 1 is a diagram showing cells of conventional satellite communication system and terrestrial communication system.

Generally, the cell (beam) of the satellite communication system is very larger than the cell of the terrestrial communication system. In other words, as shown in FIG. 1, a large number of terrestrial cells are included in one region of a satellite cell. Therefore, in the case of the broadcast and multicast services which accompanies point-to-multipoint (P-T-M) transmission, a satellite having a broad cell region has its advantages. In other words, the satellite communication system can provide many users with services by transmission from only one cell, as contrasted with the terrestrial communication system, which needs a large number of cells to simultaneously transmit the same data.

When considering the above-mentioned matters, it is preferable that the satellite communication system mainly performs the PTM transmission in an integrated communication system including the terrestrial communication system and the satellite communication system.

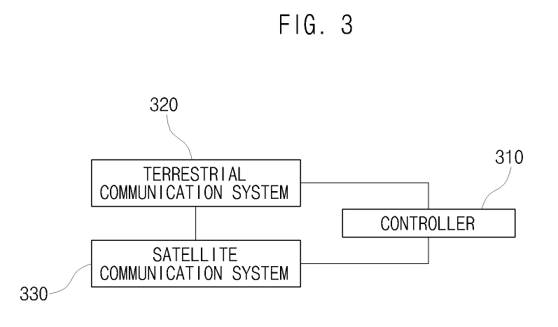

FIG. 2 is an arrangement example of a broadcast and multicast channel, a communication channel, and a convertible channel in the resource allocation method according to an exemplary embodiment of the present invention.

When providing the broadcast and multicast services and the communication services in one system, the channel can be separated in the same manner as (1) of FIG. 2. In other words, the channel is separated into two, one for the broadcast and multicast services and the other for the communication services.

Generally, the broadcast services occupy the channel constantly. On the other hand, the multicast services do not occupy the channel constantly since the channel use of multicast services depends on the existence of a multicast service user. Therefore, when dividing the channel as (1) of FIG. 2, there is a disadvantage in that the channel occupied for the multicast services cannot be used for the communication services even when there is a demand for more communication services and no multicast service user.

In order to compensate these disadvantages, the convertible channel shown in (2) or (3) of FIG. 2 can be set in the middle. The convertible channel is a channel that can be converted according to the usage of the multicast services or the communication services. As a result, the channel efficiency can be increased. At this time, the range of the channel allocated to the broadcast channel, the multicast channel, the convertible channel, and the communication channel among all the channels, respectively, can be defined as needed. The type of the communication system (terrestrial communication system or satellite communication system) providing services, the usage of the service, etc. may be the factors to be considered.

In other words, (2) of FIG. 2 can be the arrangement example of the channel in the terrestrial communication system, and (3) of FIG. 2 may be the arrangement example of the channel of the satellite communication system. For the satellite communication system, it is preferable to allocate more bandwidth for the predominant broadcast and multicast services as well as the convertible channel to provide more multicast services if necessary.

With the convertible channel, the resource use efficiency of the entire communication system may be increased as well as that of the individual cell (base station) through the multicast service switching between the terrestrial communication system and the satellite communication system.

As described above, each cell of the satellite communication system can provide a lot more users with services than that of the terrestrial communication system. Therefore, when the number of the cells of the terrestrial communication system providing the same multicast services increases, the corresponding multicast services can be switched to the satellite communication system. Then, the channel occupied by the corresponding services becomes available for new multicast service or the communication service.

In order to do this, a criterion for the number of the terrestrial cells providing the same multicast services for switching to the satellite cell should be determined. The following [Equation 1] is used for the criterion.

NBS(i)>Thresh_{NBS}, [Equation 1]

where NBS(i) is the number of cells (base stations) providing i multicast services and Thresh_{NBS} is a threshold value determining whether to switch to the satellite communication system. A system operator can set the threshold.

A specific terrestrial cell can request a service switching to the satellite communication system when communication channel is insufficient in addition to the above-mentioned case where many terrestrial cells provide the same multicast services. In this case, it is preferable that the service being provided from the most cells among the multicast services from the cell requested switching is switched. On the other hand, when the communication capacity of the satellite communication system is not well enough, the multicast service being provided from the fewest cells should be switched.

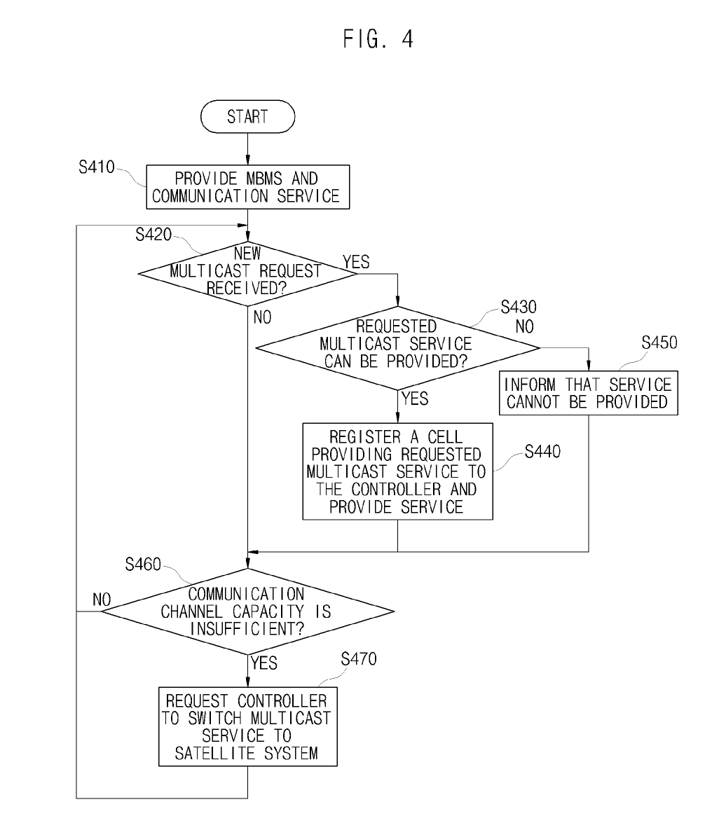

FIG. 3 is a diagram showing a concept of a controller for controlling the above-described service switching. FIG. 3 only shows a logical relationship not a physical structure. The controller may be disposed at various positions depending on the network architecture during actual implementation. In particular, the controller may be included as a portion of the terrestrial communication system or the satellite communication system.

As shown in FIG. 3, a controller 310 is connected to both a terrestrial communication system 320 and a satellite communication system 330, such that it has a structure capable of obtaining information on currently provided services from both systems and issuing a command for switching multicast services.

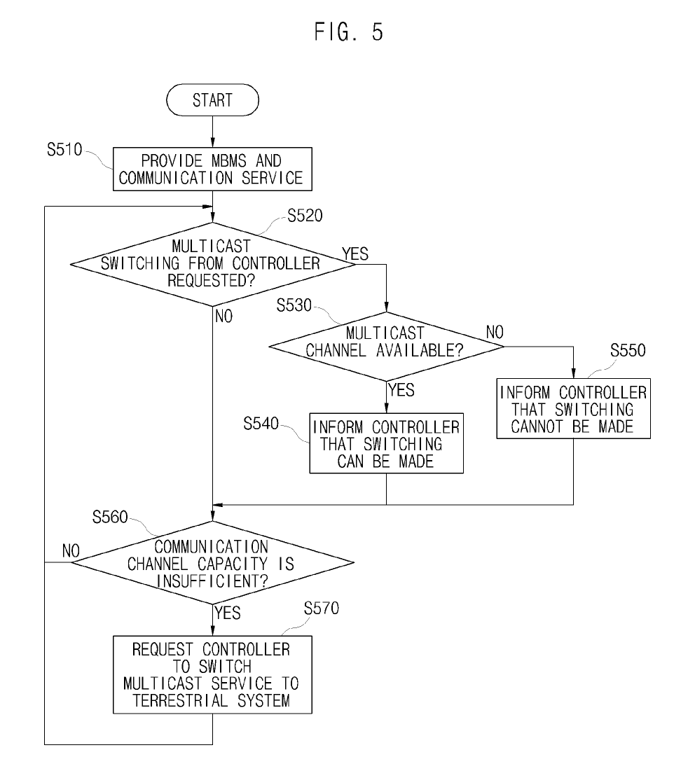

FIG. 4 is a flowchart showing an operation in a cell of a terrestrial communication system when applying a resource allocation method according to an exemplary embodiment of the present invention.

As shown in FIG. 4, when the MBMS services and the communication services are provided from the terrestrial communication system (S410), if a request of new multicast service (multicast service not currently provided from any communication system) is received (S420), the terrestrial communication system determines whether there is a channel available for providing the requested multicast service (S430).

As it is determined that the requested service can be provided, the terrestrial communication system sends a message informing the controller that a terrestrial cell provides the requested multicast service to be registered as a cell providing that multicast service, and the cell starts to provide the requested multicast service (S440). If it is determined that no cells can provide the requested service, the controller is informed that the service cannot be provided (S450).

Next, it is determined whether the capacity of the current communication channel is insufficient (S460). If it is insufficient, the terrestrial communication system sends a request to the controller to switch multicast services to the satellite system (S470).

Meanwhile, the terrestrial communication system may consider that it receives a request of new multicast service as in step S420 of FIG. 4, when the controller attempts the multicast service switching to the terrestrial communication system due to the insufficient capacity of the satellite communication system. It is also possible that a higher priority is given for the switching request due to the insufficient communication capacity.

The switching process in order to provide the multicast services through the satellite communication system uses the same frequency as the satellite communication system also include the multicast services provided through an ancillary terrestrial component (ATC) that provides services in a shadow area on the ground, and the like. That is, the satellite communication system also refers to any system using the same frequency as that of the satellite system.

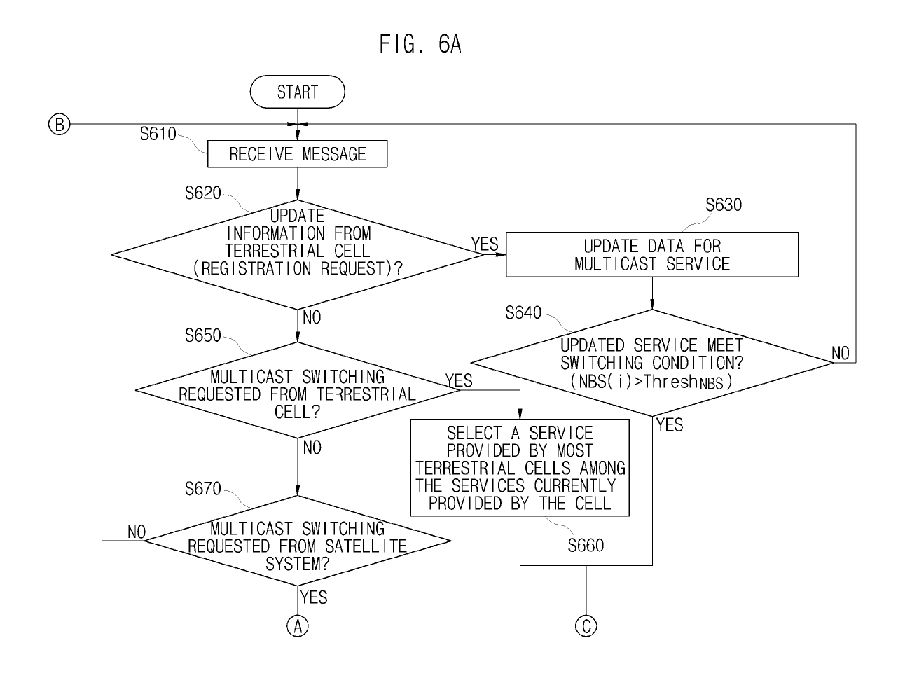

FIG. 5 is a flowchart showing an operation in a cell of a satellite communication system when applying a resource allocation method according to an exemplary embodiment of the present invention.

As shown in FIG. 5, when the MBMS services and communication services are provided from the satellite communication system (S510), it is confirmed whether there is a multicast service available channel (S530) when a multicast service switching is requested from the controller (S520).

When there is an available channel, it is informed to the controller that the multicast switching can be made (S540), and when there is no available channel, it is informed to the controller that the multicast switching cannot be made (S550). After it is confirmed that the capacity of the current communication channel is insufficient (S560), it requests the controller to switch the multicast services to the terrestrial system when the capacity is insufficient (S570).

Although not shown in FIG. 5, an operation of the satellite communication system when a multicast service is directly requested is similar to the operation of the terrestrial communication system described with reference to FIG. 4. In other words, it is informed that if there is an available channel, the services are provided and if not, the services cannot be provided. In this case, however, it is not necessary to inform that the corresponding services provide the controller as in the terrestrial communication system.

Generally, the satellite communication system provides a service to a broad area, it is preferable to adopt a hierarchical manner that makes the terrestrial cells to initially support the multicast services and uses the satellite communication only when a demand for the multicast services exceeds a predetermined criteria. If there is the channel capable of sufficiently providing the multicast services even in the terrestrial cell, it is wasting the resources that only a small number of users request the multicast services to the satellite communication system. However, when all the resources of the terrestrial cells are being used, the multicast services will be immediately requested to the satellite communication system.

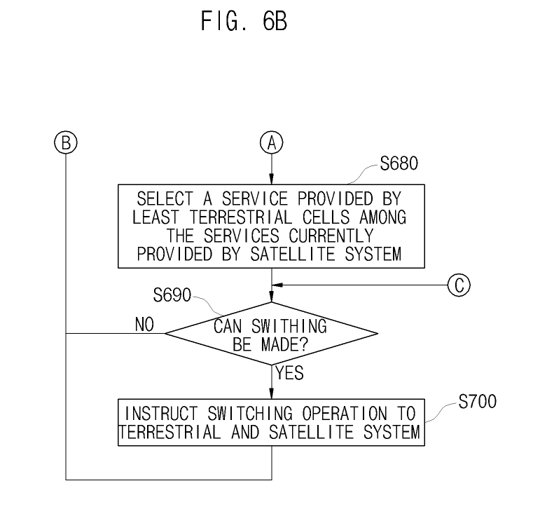

FIG. 6 is a flowchart showing an operation of the controller when applying a resource allocation method according to an exemplary embodiment of the present invention.

A method for operating the controller may use a method of operating the controller when receiving new messages, a method of periodically operating the controller, or a mixed method thereof. FIG. 6 shows an example of the operation when messages are received.

As shown in FIG. 6, when the controller receives a message (S610), it performs an operation according to the contents of the message. If the message corresponds to update information of the cell of the terrestrial communication system, that is, information that the multicast services are newly provided or information that the previously provided multicast services is not provided (S620), the controller updates data for the corresponding multicast (S630) and checks if the updated services meets the switching condition (S640). The switching condition is the same as expressed in Equation 1.

When the updated information meets the switching condition, it is confirmed that the switching to the satellite communication system can be made (S690). If so, the controller instructs the terrestrial communication system and the satellite communication system to switch the multicast service (S700).

When the received message is not an update information of the cell of the terrestrial communication system but is a multicast switching request from the terrestrial cell (S650), the controller selects a multicast service that most terrestrial cells are providing among the currently provided services of the cell requested multicast switching (S660) and confirms to the satellite communication system whether the selected service can be provided (S690). Then, the controller orders the terrestrial communication system and the satellite communication system to perform the switching operation (S700).

When the received message is a multicast switching request from the satellite communication system (S670), the controller selects a service that least terrestrial cells are providing among the currently provided services of the satellite communication system (S680). Then, it confirms that the terrestrial communication system can provide the selected service (S690) and instruct the terrestrial communication system and the satellite communication system to switch the multicast service (S700).

If the multicast service switching with a hetero system of the terrestrial communication system is made, the above-mentioned controller may not be needed. In other words, if there is a hetero communication system capable of providing the services to the corresponding cell area, the multicast service switching can be made through the message exchange between the base station wishing to switch the multicast service and the base station capable of providing the service to the area. However, since this switching is less efficient in using the resources than the switching to the satellite, it is more preferable to use this switching method when the capacity of the communication channel is insufficient and it is not easy to switch to the satellite. In other words, it can perform the switching when it is impossible or inefficient to switch to the satellite communication system through the controller and there is other terrestrial system capable of providing the corresponding services to the corresponding area.

While certain embodiments have been described above, it will be understood to those skilled in the art that the embodiments described can be modified into various forms without changing the technical spirit or essential features. Accordingly, the embodiments described herein are provided by way of example only and should not be construed as being limited. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A resource allocation method in an integrated communication system including a terrestrial communication system, a satellite communication system, and a controller connected to both the terrestrial communication system and the satellite communication system, comprising:
the controller determining whether the number of cells providing the same multicast service among the cells of the terrestrial communication system is equal to or larger than a predetermined threshold value and there is a channel available for an additional multicast service in the satellite communication system;
if it is determined that the number of cells providing the same multicast service among the cells of the terrestrial communication system is equal to or larger than the predetermined threshold value and there is a channel available for an additional multicast service in the satellite communication system, the controller performing a control to switch the multicast service being provided by the terrestrial communication system to the satellite communication system and to stop the multicast service being provided by the terrestrial communication system.

2. The method of claim 1, further comprising:
the controller or the terrestrial communication system determining whether the capacity of the communication channel of the terrestrial communication system is insufficient;
the controller or the satellite communication system determining whether there is a channel available for an additional multicast service to the satellite communication system; and
if it is determined that the capacity of the communication channel of the terrestrial communication system is insufficient and there is a channel available for an additional multicast service in the satellite communication system, the controller performing a control to switch the multicast service being provided by the terrestrial communication system to the satellite communication system and to stop the multicast service being provided by the terrestrial communication system.

3. The method of claim 1, wherein the controller performs a control to switch a multicast service provided by most cells among the cells of the terrestrial communication system to the satellite communication system when two or more multicast services are being provided by the terrestrial communication system.

4. The method of claim 2, wherein the controller controls to switch a multicast service provided by most cells among the cells of the terrestrial communication system to the satellite communication system when two or more multicast services are being provided by the terrestrial communication system.

5. The method of claim 4, further comprising:
the controller or the satellite communication system determining whether the capacity of the communication channel of the satellite communication system is insufficient;
the controller or the terrestrial communication system determining whether there is a channel available for an additional multicast service in the terrestrial communication system; and
if it is determined that when the capacity of the communication channel of the terrestrial communication system is insufficient and there is a channel available for an additional multicast service in the terrestrial communication system, the controller performing a control to switch the multicast service being provided by the satellite communication system to the terrestrial communication system and to stop the multicast service being provided by the satellite communication system.

6. The method of claim 5, wherein the controller perform a control to switch a multicast service which can be provided by least cells among the cells of the terrestrial communication system to the terrestrial communication system when two or more multicast services are being provided by the satellite communication system.

7. A resource allocation controller for controlling resource allocation for multicast services in an integrated communication system including a terrestrial communication system and a satellite communication system, characterized in that:
the controller is connected to the terrestrial communication system and the satellite communication system to receive information on services currently provided by the terrestrial communication system and the satellite communication system, and
when the number of cells providing the same multicast service among cells of the terrestrial communication system is equal to or larger than a threshold value and there is a channel available for an additional multicast service in the satellite communication system, the controller performs a control to switch the multicast service being provided by the terrestrial communication system to the satellite communication system and to stop the multicast service being provided by the terrestrial communication system.

8. The resource allocation controller of claim 7, wherein:
each of the terrestrial communication system and the satellite communication system has a broadcast channel for providing broadcast services, a multicast channel for providing multicast services, a communication channel for providing communication services, and a convertible channel; and
the convertible channel is used to provide either the communication services or the multicast services.

9. A resource allocation method in an integrated communication system including a first communication system and a second communication system capable of providing multicast services to the same area as of the first communication system,
wherein each of the first communication system and the second communication system has a broadcast channel for providing broadcast services, a multicast channel for providing multicast services, a communication channel for providing communication services, and a convertible channel which can be used for either communication services or multicast services; and
the first communication system and the second communication systems selectively providing communication services or multicast services through the convertible channel.

10. The method of claim 9, wherein:
the first communication system is a terrestrial communication system;
the second communication system is a satellite communication system; and
when the number of cells providing the same multicast service among the cells of the terrestrial communication system is equal to or larger than a predetermined threshold value and there is a channel available for an additional multicast service in the multicast channel or the convertible channel of the satellite communication system, the multicast service being provided by the terrestrial communication system is switched to the satellite communication system and the terrestrial communication system stops providing the multicast service.

11. The method of claim 9, wherein:
the first communication system is a terrestrial communication system; and
when the capacity of the communication channel of the terrestrial communication system is insufficient and there is a channel available for an additional multicast service in the multicast channel or the convertible channel of the second communication system, the multicast service being provided by the terrestrial communication system is switched to the second communication system and the terrestrial communication system stops providing the multicast service.

12. The method of claim 11, wherein:
the second communication system is a satellite communication system; and
when two or more multicast services are being provided by the terrestrial communication system, a multicast service provided by most cells among the cells of the terrestrial communication system is switched to the satellite communication system.

13. The method of claim 9, wherein, when the capacity of the communication channel of the second communication system is insufficient and there is a channel available for an additional multicast service in the multicast channel or the convertible channel of the first communication system, the multicast service being provided by the second communication system is switched to the first communication system and the second communication system stops providing the multicast service.

14. The method of claim 13, wherein:
the first communication system is a terrestrial communication system;
the second communication system is a satellite communication system; and
when two or more multicast services are being provided by the satellite communication system, a multicast service which can be provided by least cells among the cells of the terrestrial communication system is switched to the terrestrial communication system.

15. The method of claim 9, wherein:
the first communication system is a terrestrial communication system; and
the second communication system is a terrestrial communication system of a different kind from the first communication system.

16. The method of claim 15, wherein the second communication system is an ancillary terrestrial component (ATC) that uses the same frequency as a satellite communication system to provide services in a shadow area on a ground.
